(19) United States
(12) Patent Application Publication
(10) Pub. No.: US 2019/0381344 A1
(43) Pub. Date: Dec. 19, 2019

(54) Fire Protection Boards And Structures Protected By Such Boards

(71) Applicant: Thermal Ceramics De France, Andrézieux - Bouthéon (FR)

(72) Inventor: Craig FREEMAN, Wirral Merseyside (GB)

(21) Appl. No.: 16/479,110

(22) PCT Filed: Jan. 18, 2018
(86) PCT No.: PCT/EP2018/051252

§ 371 Date: Jul. 18, 2019

(30) Foreign Application Priority Data
Jan. 20, 2017 (GB) 1700969.7

(51) Int. Cl. A62C 3/06; C04B 28/24; A62C 3/10; A62C 3/02; C04B 28/34; C04B 30/02; C09K 21/02; E04B 1/94; E21F 5/00; E21D 11/15; C04B 28/04

(52) U.S. Cl. CPC A62C 3/06; C04B 28/24; A62C 3/10; A62C 3/02; C04B 28/34; C04B 2111/0062; C09K 21/02; E04B 1/942; E21F 5/00; E21D 11/15; C04B 28/04; C04B 30/02

(57) ABSTRACT

A self supporting board for use in fire protection, at least part of the board being formed from material comprising in wt %: inorganic fibres 35 to 70% silica 30 to 65% 5 binder 0 to 10%.

This invention relates to materials for use in fire protection and panels and shapes made of such materials. The invention is particularly, although not exclusively, applicable to materials used for passive fire protection in tunnels.

Fires in tunnels are difficult to control and can be devastating. The confined nature of tunnels limits escape of heat, and the tunnels can act as flues, driving a fire to high temperatures than would be seen in an open air fire. Although tunnels typically provide refuges and escape routes for persons using the tunnels, these require protection from fire, and this protection can sometimes fail. A prolonged fire can also cause damage to the structure of a tunnel requiring major engineering work to remedy. Even relatively small fires can cause damage to electrical services in a tunnel.

For these reasons modern tunnel design (and in many countries, by regulation) require the use of both passive and active fire protection systems.

Passive fire protection systems typically provide a lining of refractory material sufficient to delay the progress of a fire and provide insulation to critical parts of the tunnel.

Tests for fitness of materials used for tunnel fire protection measure resistance for a specified time (typically 2 hours) against exposure to a specified heating regime (fire curve).

For example, for protection of reinforced concrete, the Rijkswaterstaat (RWS) (Dutch regulations) fire curve uses a temperature curve that:
ramps up rapidly to over 1150° C. after 5 minutes;
to 1200° C. at 10 minutes;
reaches 1300° C. at 30 minutes;
1350° C. at 60 minutes;
cools down through 1300° C. at 90 minutes
to 1200° C. at 120 minutes (and is maintained at this temperature for longer if a longer duration is specified for the test).

The requirement for passing the test is that the temperature of the reinforcement in the concrete behind the fire protection should not exceed 250° C., and the interface between the fire protection and the concrete should not exceed 380° C. Temperature measurement is by thermocouples embedded in the concrete and at the concrete face nearest the source of heat.

A similar test, the Modified Hydrocarbon (HCM) fire curve reaches 1300° C. at 30 minutes and maintains this temperature until the end of the test at 120 minutes.

Such passive fire protection systems include:
Cements—which are typically, sprayed, cast or trowelled to surfaces requiring fire protection.
Boards—which are mounted to surfaces requiring fire protection, either directly abutting the surfaces or spaced from the surfaces.

Boards used in tunnel fire protection include:—

### Calcium Silicate Boards.

These comprise calcium silicate and optionally binders and refractory fillers. One such board comprises calcium silicate with an alumina filler and has: a quoted density of ˜900 kg·m⁻³; reported thermal conductivity ˜0.212 W·m⁻¹·K⁻¹ at 20° C.; and is available in thicknesses of 25-40 mm. Typically, to pass a two hour test under the RWS fire curve such boards need to be of the order of 25 mm or more thickness.

### Cement Boards

Such boards comprise cements using light weight aggregates such as perlite or expanded glass granulate and optionally comprise glass fibres as reinforcement. One such board has: a quoted density of ˜690-980 kg·m⁻³; reported thermal conductivity ˜0.175 W·m⁻¹·K⁻¹ (assumed to be at ambient); and is available in thicknesses of 20-60 mm. Typically, to pass a two hour test under the RWS fire curve such boards need to be of the order of 35 mm or more thickness.

### Magnesia Boards

These are rigid fire protection panels made from magnesium oxide with silicates and other additives, and finished with a fibreglass mesh. One range of such boards have: a quoted density of ˜650-700 kg·m⁻³; reported thermal conductivity ˜0.19-0.27 W·m⁻¹·K⁻¹ (assumed to be at ambient); and is available in thicknesses of 8-40 mm. Typically, to pass a two hour test under the RWS fire curve such boards need to be of the order of 30 mm or more thickness.

Problems inherent to calcium silicate, cement, and magnesia boards include—
their density, which can make them difficult to handle and secure in place;
dustiness in machining during installation;
the hydrophilic alkaline nature of calcium silicates, which as a dust can be unpleasant to skin/eyes.

### SUMMARY OF THE INVENTION

In a first aspect of the present invention there is provided a self-supporting board for use in fire protection, at least part of the board being formed from a material comprising in wt %:—

| | |
|---|---|
| inorganic fibres | 35 to 70% |
| silica | 30 to 65% |
| binder | 0 to 10% |

In a preferred embodiment, at least part of the board is formed from a material comprising in wt %:

| | |
|---|---|
| inorganic fibres | 46 to 70% |
| silica | 30 to 54% |
| binder | 0 to 10% |

The silica preferably comprises or consists of amorphous silica. In one embodiment, the board comprises fused silica, which contributes to low thermal expansion properties of the board. This is particularly important where a plurality of board is used for fire protection and the mechanical integrity of the board is required at high temperatures.

The inorganic fibres may be any suitable inorganic fibres able to withstand the RWS test at 120 minutes and/or 180 minutes. More preferably the inorganic fibres are low biopersistence inorganic fibres.

The self-supporting boards of the present invention provide excellent fire protection whilst maintaining a low unit weight, whilst having sufficient mechanical strength. The low weight of the boards combined with the low shrinkage characteristics at high temperatures enables larger and thinner boards to be configured into a fire protection system, particular for applications covering large surface areas, such as lining road or rail tunnels.

To lower board density, the inorganic fibre content is preferably greater than 45 wt %, more preferably greater than 48 wt %, even more preferably greater than 50 wt % and yet even more preferably greater than 55 wt %. A higher fibre content enables a lower density board to be produced.

The silica content is preferably greater than 35 wt %, more preferably greater than 40 wt % or at least 45 wt % and even more preferably greater than 50 wt %. Silica contents lower than 30 wt % are prone to producing boards with increased shrinkage at high temperatures.

The density of the board is preferably between 350 and 790 kg/m³, more preferably between 375 and 740 kg/m³, even more preferably between 390 and 700 kg/m³ and yet even more preferably between 400 to 600 kg/m³. The shrinkage of the board at 1400° C. for 24 hours is preferably less than 10%, more preferably less than 6%, even more preferably less than 5% and yet even more preferably less than 2%.

The thermal conductivity of the board at 1000° C. is preferably less than 0.22 W/mk, more preferably less than 0.21 W/mk and even more preferably less than 0.20 W/mk.

Preferably the board passes the RWS test (120 minutes) and has a thickness of less than 25 mm, more preferably less than 25 mm and even more preferably less than 22 mm. The minimum thickness of the board is preferably at least 18 mm and more preferably at least 20 mm.

Preferably the board passes the RWS test (180 minutes) and has a thickness of 30 mm or less, more preferably less than 28 mm and even more preferably less than 25 mm. The minimum thickness of the board is preferably at least 20 mm and more preferably at least 22 mm.

The present invention is as further set out in the claims, and preferably provides a self-supporting board for use in fire protection, at least part of the board being formed from a material comprising low biopersistence inorganic fibres, amorphous silica, and optionally binders in the amounts set out in the claims.

Further feature of the present disclosure are illustrated in the following non-limitative description in which:—

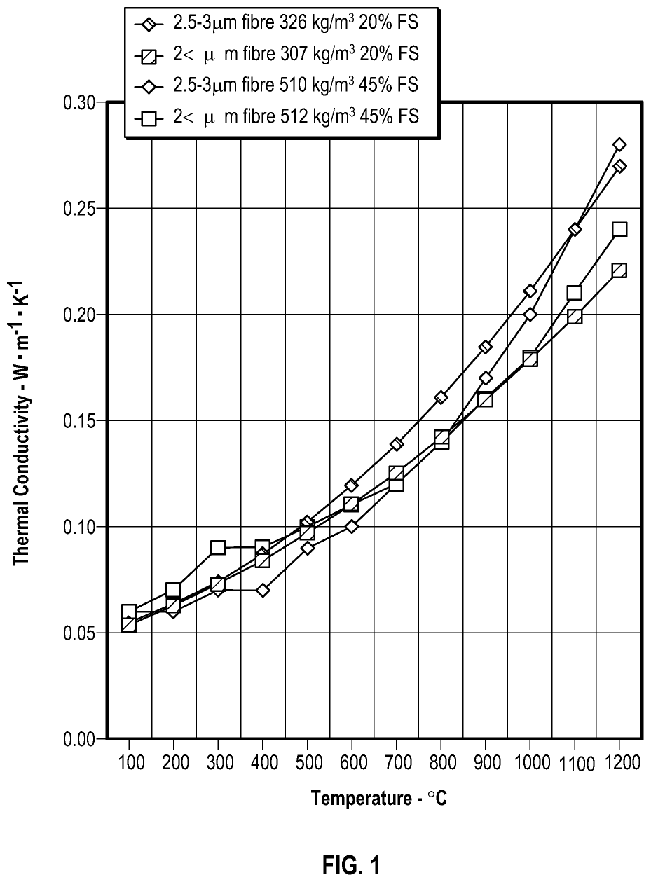

FIG. 1 shows measured thermal conductivities of a range of boards in accordance with the present invention;

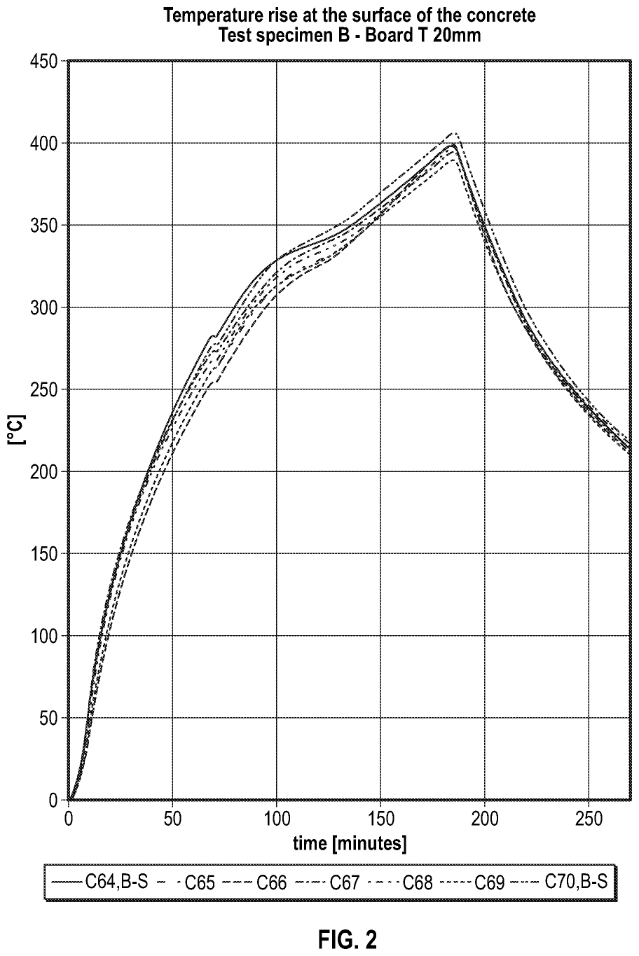

FIG. 2 shows concrete surface temperature obtained using a 20 mm thick board when exposed to the RWS fire curve;

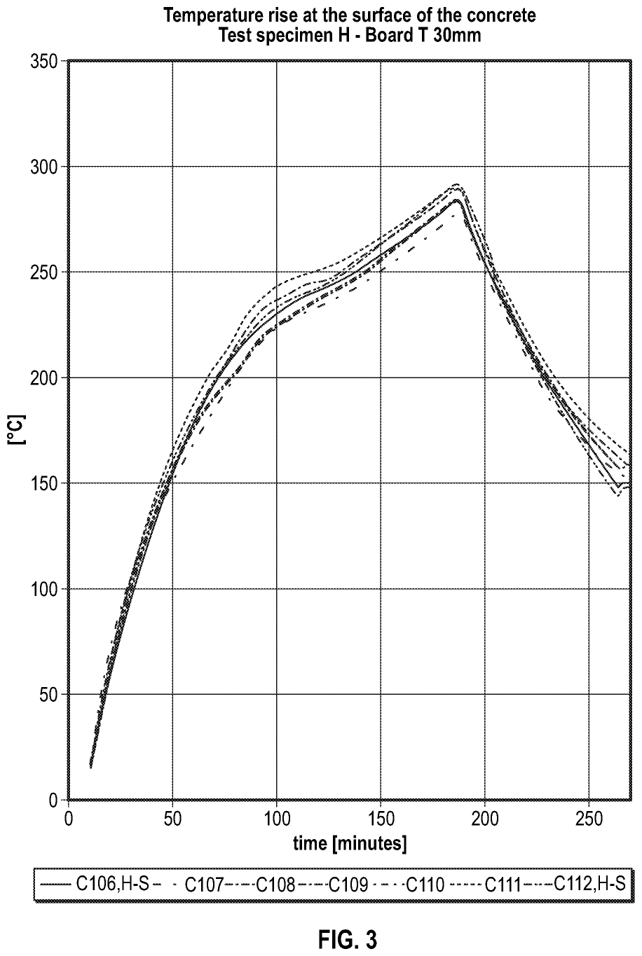

FIG. 3 shows concrete surface temperature obtained using a 30 mm thick board when exposed to the RWS fire curve;

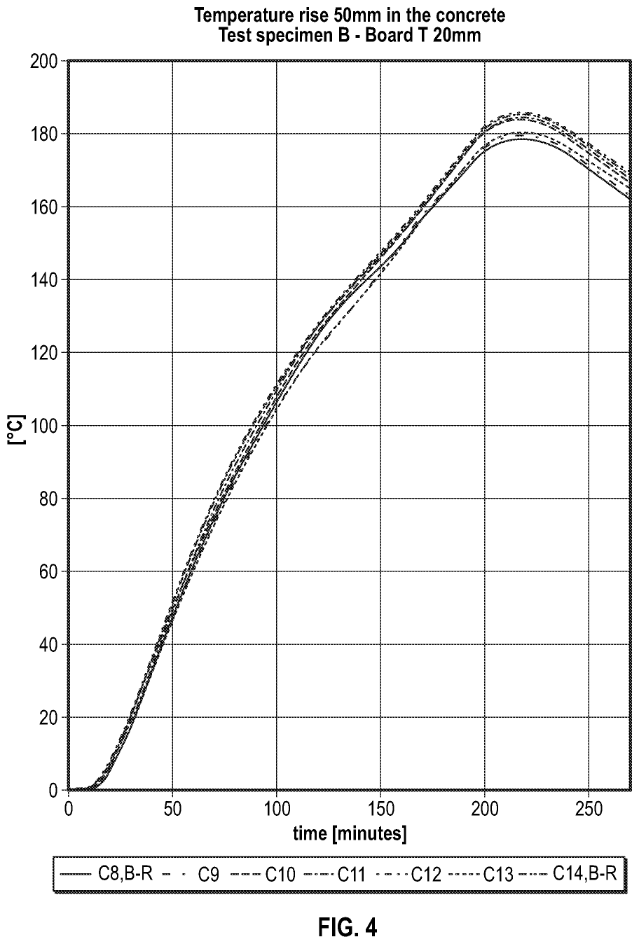

FIG. 4 shows temperatures at 50 mm below the concrete surface obtained using the 20 mm board of FIG. 2 when exposed to the RWS fire curve; and

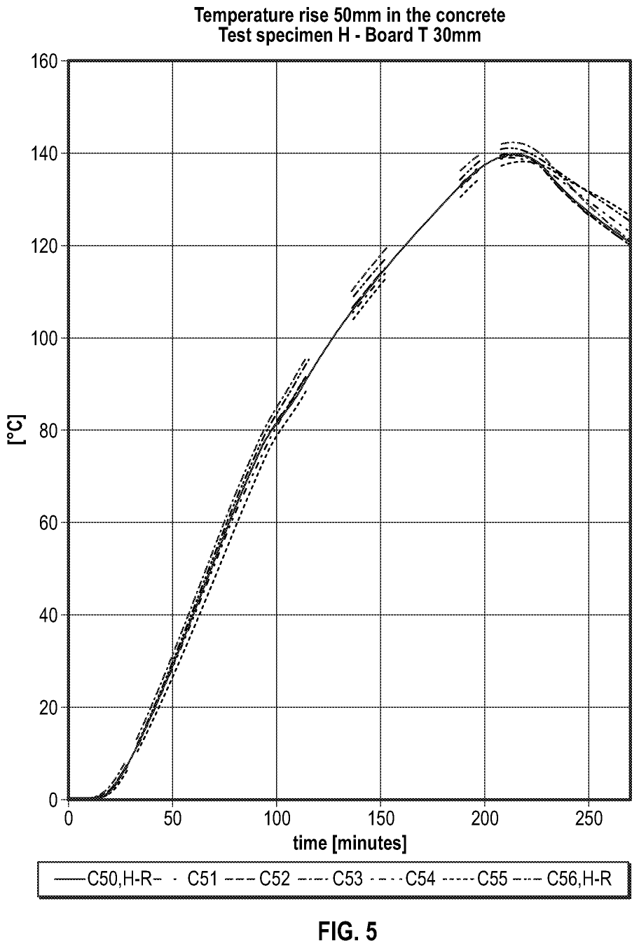

FIG. 5 shows temperatures at 50 mm below the concrete surface obtained using the 30 mm board of FIG. 3 when exposed to the RWS fire curve.

### COMPONENTS

In the present specification, the term “low biopersistence inorganic fibres” should be taken as encompassing alkaline earth silicate fibres, alkaline earth aluminates, alkali metal aluminosilicates, and other fibres that are readily cleared by the lung's physiological clearance mechanism.

A definition that can be applied is as meaning fibres that have a weighted half life of <40 days when measured by the intratracheal installation test method ECB/TM/27 rev.7 [http://tsar.jrc.ec.europa.eu/documents/Testing-Methods/mmmfweb.pdf—April 1999].

Alkaline earth silicate fibres are generally formed from the melt and include, inter alia, magnesium silicate fibres, calcium magnesium silicate fibres, and calcium silicate fibres. Alkaline earth silicate fibres frequently comprise other components either as impurities or to achieve particular mechanical, thermal, or biological effects (e.g. iron oxides, alkali metal oxides, aluminium oxide, phosphorus oxides, and mixtures thereof).

Alkali metal silicate fibres are generally formed from the melt and include, inter alia, potassium aluminosilicate fibres such as disclosed in WO2008/065363, WO2009/066076 and WO2015/011439.

Fine diameter low biopersistence fibres (i.e. low biopersistence inorganic fibres with arithmetic mean diameter <2 μm) provide low thermal conductivity to a body of fibres by reducing the scope for conduction through the solid and permitting finer inter-fibre porosity, increasing the number of radiate-absorb steps for heat to pass by radiation from one side of the body to the other.

A commercially available alkaline earth silicate fibre SUPERWOOL® PLUS, (made by proprietary technology) has a classification temperature of 1200° C. (EN 1094-1) and has:—
a typical composition comprising in weight percent

| | |
|---|---|
| SiO₂ | 64-66% |
| CaO | 27-31 |
| MgO | 4-7 |
| Al₂O₃ | <0.8 |
| Others (including Al₂O₃) | <1. |

“Other” in the above context means any other material and typically these comprise oxides although other materials (e.g. fluorides) may be present.
fibre diameters in the range 2.5-3 μm

Another commercially available alkaline earth silicate fibre for use at higher temperatures is SUPERWOOL® HT (made by proprietary technology), which has a classification temperature of 1300° C. (EN 1094-1) and has:—
a typical composition comprising in weight percent

| | |
|---|---|
| SiO₂ | 73-74.5 wt % |
| CaO | 22.2-26 wt % |
| MgO | 0.4-0.8 wt % |
| Al₂O₃ | 0.9-1.4 wt % |
| K₂O | 0.5-0.8 wt % |

with any other components or impurities amounting to at most 0.3 wt %.
fibre diameters in the range 3-3.5 μm arithmetic mean.

The applicant's co-pending applications GB2546310 and WO2017/121770 disclose processes for producing fibres of like composition to SUPERWOOL® PLUS and SUPERWOOL® HT with arithmetic mean diameters <2 μm.

Typically, the higher the silica content of the fibres, the more refractory they are; but if too high biosolubility drops. Refractory alkaline earth silicate fibres that retain biosolubility typically have silica contents in the range 58%-80% and may comprise >60% or >70% silica.

Amorphous silica is an amorphous (glassy) form of silica that can be made in a variety of ways, and includes, as examples, fused silica and fumed silica. The examples of the present disclosure have used fused silica, but the present invention is not restricted thereto. It should be noted that fused silica is less likely to form fine dust than fumed silica.

Fused silica is made by melting a high purity silica, solidifying the melt to form an amorphous mass, and crushing the amorphous mass into a powder.

In the examples given below the fused silica used was from Dupré Minerals, quality −120 Grade which is 99.8% SiO₂ and has a d10 6.06 μm, d50 39.7 μm and d90 124.5 μm

Typical inorganic binders that might be used include, for example: colloidal silica, colloidal alumina, colloidal aluminosilicate, colloidal zirconia, aluminium chlorohydrate, phosphates, and mixtures thereof.
In the examples given below the inorganic binder used was a colloidal silica Köstrosol 1530 from CWK, with a 30% by weight solids content and a specific area of 185 m²·g⁻¹.

Colloidal materials comprise microscopically dispersed insoluble particles in another substance. In the present specification the term “colloidal” is to be understood as having a particle size less than 1 μm.

Typical organic binders that might be used include, for example: starch and/or other polysaccharides, phenolic resins, and acrylics. In the examples given below the organic binder used comprised a starch, for instance HiCat 1164A grade from Roquette. It is preferable that if present, these binders be only present in low quantities [e.g. ≤5%, ≤4%, ≤3%, <2% or even ≤1%].

The liquid phase in a slurry or suspension usable in manufacture of the present products is typically water but other liquids may be used to choice.

### Processes

A method of making boards is the Fourdrinier process which uses a machine typically comprising a forming section, in which the suspension drains onto a mesh conveyor belt to form a wet web, and a drying section where the wet web is dried by heat. Typically a press section may be provided between the forming section and the drying section, where the wet web is compressed to squeeze out fluid before the web passes to the drying section. A calendaring section may be provided after the drying section to smooth the board surface. The Fourdrinier process typically enables higher loadings of particulate materials to be provided than in vacuum forming (described below), but the present invention is not limited to materials made by the Fourdrinier process.

An alternative method used to form boards and other shaped products is by vacuum forming, in which a suspension of fibre with an organic binder and an inorganic binder is produced. The organic binder and inorganic binder flocculate, drawing the fibre into a flocculated suspension.

The suspension is placed in contact with mesh moulds and vacuum is applied to the moulds to vacuum form articles either on the outside of the mesh (male mould) or on the inside of the mesh (female mould). Vacuum is applied to the mould until a sufficient thickness of fibre has built up and the mould is then removed from the suspension, the vacuum remaining on for a little while to promote dewatering. This process produces a wet green article containing about 50%-70% water.

At this stage the product is normally fragile having the consistency of wet cardboard. The wet green article is dried, for example at a temperature of about 150° C. and the organic binder then gives handling strength.

Alternative methods, for example pressing or casting, are not precluded by this disclosure, but generally preparing a slurry or suspension and removing the liquid phase is convenient.

### EXAMPLES

### Shrinkage and Thermal Conductivity

Boards of approximately 800 mm×300 mm were made from a suspension to produce the materials of the thicknesses and properties set out in Table 1 at the end of this description.

In Table 1, “Alkaline earth silicate fibres A” are SUPERWOOL®HT fibres as described above with an arithmetic average fibre diameter in the range 2.5-3 μm and a shot content in the range 45-50% by weight: and “Alkaline earth silicate fibres B” are fibres of like composition with an arithmetic average fibre diameter <2 μm and having a shot content in the range 30-35% by weight.

Shrinkage of the boards were measured after exposure to 1400° C. for 24 hours (i.e to temperatures well above the RWS and HCM fire curves and for significantly longer). Measurement comprised placing platinum pins (approximately 0.4-0.5 mm diameter) 100×55 mm apart. The longest lengths (L1 & L2) and the diagonals (L3 & L4) were measured to an accuracy of ±5 μm using a travelling microscope. The samples were placed in a furnace and ramped to a temperature 50° C. below the test temperature at 300° C./hour and ramped at 120° C./hour for the last 50° C. to test temperature and left for 24 hours. The samples were allowed to cool in the furnace before removal. The shrinkage values are given as an average of the 4 measurements.

Thermal conductivities were measured by ASTM-C201.

As can be seen, the boards with 20% fused silica show high shrinkage at 1400° C. (over 5%) whereas those with 30% and 45% fused silica show significantly lower shrinkage with 45% fused silica having the lowest shrinkage.

In addition, as can be seen plotted in FIG. 1, the thermal conductivities of the boards comprising fibres with arithmetic average fibre diameter <2 μm [□] is significantly lower than the boards with arithmetic average fibre diameter in the range 2.5-3 μm [ [symbol] ]. All of the examples for which thermal conductivity has been measured show comparable or better thermal conductivities than those reported for calcium silicate boards, cement boards and magnesia boards; and at a significantly lower density.

Lower density of the boards means a lower loading on fastenings used to secure the boards in a tunnel, this can significantly affect the type and number of fastenings used to secure the boards to the tunnel, benefitting both material costs and installation costs.

However the invention is applicable to higher density boards too, and a 20 mm thick board made with 60% fused silica had a density of 730 kg·m⁻³ and a 24 hour linear shrinkage at 1400° C. of 1.2%. As the strength of the boards tends to increase with fused silica content, such refractory boards can have application where refractoriness and structural integrity is a requirement. A typical application might be as back up insulation for refractories in iron and steel making.

### Fire Test

Sample boards comprising 45% fused silica were tested for ability to withstand the RWS fire curve over a three hour timescale. FIGS. 2 and 3 show the concrete surface temperatures experienced by a number of thermocouples positioned across a tested board and respectively show the results for a 20 mm thick board and a 30 mm thick board. As can be seen the results shown in FIG. 2 for a 20 mm thick board show that it does not reach 380° C. after 120 minutes and so passes a two hour RWS test. This board is nearly good enough to pass a three hour RWS test.

As shown in FIG. 3, a 30 mm thick board comfortably passes a three hour RWS test and looks capable of resisting such a fire for considerably longer.

Similarly FIGS. 4 and 5 show the temperatures experienced at 50 mm below the concrete surface and in both cases, neither reaches the 250° C. limit for reinforcement called for in the RWS test.

Accordingly the present disclosure describes boards that can pass a 2 hour RWS test at thicknesses as low as about 20 mm, and a 3 hour RWS test at thicknesses between about 20 mm and 30 mm. This, in combination with the lower density of such boards, enables a given requirement for fire protection to be met with a lighter structure than conventional tunnel fire protection boards: or permits a given weight of structure to provide fire protection for much longer than conventional tunnel fire protection boards.

The low shrinkage of the present materials at 1400° C. and the above results for an RWS test indicates that these boards will meet tests using the HCM fire curve.

The table below summarises the commercially available board (Promat, Fermacell—Aestuver and Mercor) with the boards of the present invention. Different boards were used for each of the RWS120 and RWS 180 tests. The results confirm that the boards of the present invention are significantly lighter.

| | | | MERCOR | Present |
|---|---|---|---|---|
| TEST | PROMAT | AESTUVER Tx | Tecbor B | Invention |
| RWS 120 | Pass | Pass | Pass | Pass |
| Thickness | 25 to | 20 mm + | 24 mm | 20 mm |
| | 27.5 mm | 10 mm* | | |
| Density (kg/m³) | 945-975 | 966 | 925 | 470-512 |
| RWS 180 | — | Pass | Pass | Pass |
| Thickness | — | 30 mm | 40 mm | 30 mm |
| Density (kg/m³) | — | 853 | 925 | 470-512 |

### Notes:

Aestuver Tx for RWS 120 min require 20 mm board+10 mm air gap with backing strips. Boards are attached after concrete tunnel walls/roof are constructed.

Comparative boards are attached to concrete with a minimum strength category of C25/C35. Boards of the present invention attached to concrete with a minimum strength category of C35/C45.

PROMAT test certificate: Exova CF 647 Promatect T (25 mm board)
1. Exova CF 548 Promatect H (27.5 mm board)
   AESTUVER Tx test certificate: 2014-Efectis R 0160 (RWS 120 and 180)
   MERCOR Tecbor B test certificate: 2015-Efectis—R000911 (RWS 120)
2011-Efectis-R0280 (RWS 180)

The above describes self-supporting boards for use in fire protection, at least part of the boards being formed from a material comprising in wt %:—

| | |
|---|---|
| low biopersistence inorganic fibres | 40-70% |
| amorphous silica | 30-60% |
| binder | 0-10%. |

The boards may further comprise facing material or support material providing additional erosion resistance, decoration, or mechanical support to the boards.

The present invention does not preclude other materials being present in the boards, for example:—
Hydrophobic materials to limit water absorption in use;
Biocides to limit attack of organic components and/or to limit colonisation by lichens;
Endothermic materials.

The present disclosure contemplates the use of organic, inorganic, or a combination of organic and inorganic binders, but preferably the amount of organic binder is kept low to reduce any heat/flame contribution from combustion in the event of fire.

It should be noted that the higher the level of fused silica, the better the mechanical properties. The examples using 45% fused silica had sufficient strength to allow cutting and fixing without difficulty, whereas those with lower levels of fused silica required greater care in fixing.

Although the above has mentioned applicability to fire protection in tunnels, the boards of the present application are also usable for fire protection in other applications, for example: for ductwork, for structural steelwork; and in marine applications to protect structural and other features in ships. The boards are also usable in other applications than for fire protection for their refractory and insulating properties.

TABLE 1

| | Comparative | | | Comparative | | | |
|---|---|---|---|---|---|---|---|
| | Example | | | Example | | | |
| Reference | 0420 | 0388 | 0404 | 0419 | 0389 | 0390 | 0408 |
| Board thickness mm | 25 | 35 | 35 | 25 | 20 | 35 | 35 |
| Target density kg/m³ | 330 | 420 | 550 | 330 | 420 | 420 | 550 |
| Components | | | | | | | |
| Alkaline earth silicate fibres A | 75.3 | 65.3 | 50.3 | | | | |
| Alkaline earth silicate fibres B | | | | 75.3 | 65.3 | 65.3 | 50.3 |
| Fused silica | 20 | 30 | 45 | 20 | 30 | 30 | 45 |
| Binder - 3.5% polysaccharide, balance | 4.7 | 4.7 | 4.7 | 4.7 | 4.7 | 4.7 | 4.7 |
| colloidal silica | | | | | | | |
| Properties | | | | | | | |
| Shrinkage @ 1400° C./24 hrs | 6.3 | 1.4 | 1.2 | 10.5 | 4.1 | 3.4 | 0.8 |
| Measured density Kg/m³ | 326.0 | | 507.2 | 316.0 | | | 511.5 |
| Calculated Thermal Conductivity (W/mk) | | | | | | | |
| Temp ° C. | | | | | | | |
| 100 | 0.05 | Not | 0.06 | 0.05 | Not | Not | 0.06 |
| 200 | 0.06 | measured | 0.06 | 0.06 | measured | measured | 0.07 |
| 300 | 0.07 | | 0.07 | 0.07 | | | 0.09 |
| 400 | 0.09 | | 0.07 | 0.08 | | | 0.09 |
| 500 | 0.10 | | 0.09 | 0.10 | | | 0.10 |
| 600 | 0.12 | | 0.10 | 0.11 | | | 0.11 |
| 700 | 0.14 | | 0.12 | 0.13 | | | 0.12 |
| 800 | 0.16 | | 0.14 | 0.14 | | | 0.14 |
| 900 | 0.18 | | 0.17 | 0.16 | | | 0.16 |
| 1000 | 0.21 | | 0.20 | 0.18 | | | 0.18 |
| 1100 | 0.24 | | 0.24 | 0.20 | | | 0.21 |
| 1200 | 0.27 | | 0.28 | 0.22 | | | 0.24 |

1. A self supporting board for use in fire protection, at least part of the board being formed from material comprising in wt %:

| | |
|---|---|
| inorganic fibres | 35 to 70% |
| silica | 30 to 65% |
| binder | 0 to 10%. |

2. A self supporting board for use in fire protection according to claim 1, wherein the silica is amorphous silica.

3. A self supporting board for use in fire protection according to claim 1, wherein the inorganic fibre is low biopersistence inorganic fibres.

4. A self-supporting board for use in fire protection, at least part of the board being formed from a material comprising in wt %:—

| | |
|---|---|
| low biopersistence inorganic fibres | 35-70% |
| amorphous silica | 30-65% |
| binder | 0-10% |

5. A self-supporting board, as claimed in claim 4, in which the material comprises in wt %:—

| | |
|---|---|
| low biopersistence inorganic fibres | 40-70% |
| amorphous silica | 30-60% |
| binder | 0-10% |

6. A self-supporting board for use in fire protection, as claimed in claim 5, in which the material comprises in wt %:—

| | |
|---|---|
| low biopersistence inorganic fibres | 45-55% |
| amorphous silica | 40-50% |
| binder | 0-5% |

7. A self-supporting board for use in fire protection as claimed in claim 2, in which the amorphous silica is or comprises fused silica.

8. A self-supporting board for use in fire protection as claimed in claim 3 in which the low biopersistence inorganic fibres comprise alkaline earth silicate fibres.

9. A self-supporting board for use in fire protection as claimed in claim 8, in which the alkaline earth silicate fibres have an arithmetic mean diameter <2 μm.

10. A self-supporting board for use in fire protection as claimed in claim 8, in which the alkaline earth silicate fibre has a composition comprising >70 wt % SiO₂.

11. A self-supporting board for use in fire protection as claimed claim 8, in which the alkaline earth silicate fibre has a composition comprising
>20 wt % CaO
with CaO+SiO₂>90 wt %, >95 wt % or >98 wt %.

12. A self-supporting board for use in fire protection as claimed in claim 1, having a density between 400 and 600 kg·m⁻³.

13. A self-supporting board for use in fire protection as claimed in claims 1, in which the binder comprises an inorganic binder, optionally in combination with an organic binder.

14. A self-supporting board for use in fire protection as claimed in claim 1, in which the amount of binder is in the range 0.5-5% by weight of the material.

15. A self-supporting board for use in fire protection as claimed in any of claim 1, in which the amount of any organic binder present is less than 3% by weight of the material.

16. A self-supporting board for use in fire protection as claimed in any of claim 1, wherein the board:
has a density in the range 350 to 790 kg/m³;
has a shrinkage at 1400° C. (24 hrs) of less than 5%; and
passes the RWS test (120 min and/or 180 min).

17. A self-supporting board for use in fire protection as claimed in claim 1, in which the self-supporting board comprises a material as specified in any preceding claim and facing material on at least one face of the self-supporting board.

18. A structure comprising a plurality of self-supporting boards mounted thereto, the self-supporting boards comprising boards as claimed in claim 1.

19. A structure as claimed in claim 18, in which the structure is a tunnel.

20. A structure as claimed in claim 18, in which the structure is a ship.
